(19) United States
(12) Patent Application Publication
(10) Pub. No.: US 2006/0119595 A1
(43) Pub. Date: Jun. 8, 2006

(54) COMPUTER SYSTEM OF COMBINING USER INTERFACE AND A DISPLAY DEVICE

(76) Inventors: Wei-Yi Hsuan, Taipei City (TW); Bor-Sheng Kuo, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/906,575

(22) Filed: Feb. 24, 2005

(30) Foreign Application Priority Data
Dec. 3, 2004 (TW) 093137430

(51) Int. Cl. G09G 5/00

(52) U.S. Cl. 345/211

(57) ABSTRACT

A computer system includes a first module including a first housing, and a main board installed inside the first housing. A central processing unit is installed on the main board for processing programs and data of the computer system. The first module further includes a power supply module installed inside the first housing for providing electric power of the computer system. The computer system further includes a second module including a second housing, a display device installed inside the second housing, and a power switch installed on the second housing for generating a power switch signal for switching on or switching off the power supply. The computer system further includes a cable electrically connected to the first module and the second module including a power switch signal wire for transmitting the power switch signal generated by the power switch to the power supply module.

### BACKGROUND OF INVENTION

1. Field of the Invention

The invention relates to a computer system, and more particularly, to a computer system of combining user interface and a display device.

2. Description of the Prior Art

In today's information society, computer systems have become essential information devices. No matter whether they are desktop personal computers, laptops, or servers, they have higher and higher operating clock rates and are utilized in more and more applications.

Generally speaking, a desktop computer can be divided into two types. The first type is a traditional computer structure of a separated host and display. The second type is an all-in-one computer structure. Please refer to FIG. 1 and FIG. 2. FIG. 1 is a front-view diagram of the traditional computer 10 of a separated host and display. FIG. 2 is a back-view diagram of the traditional computer 10. The computer 10 comprises a display 12, a host 14, a keyboard 16, a mouse 18, and a speaker 20. The host 14 comprises a housing 22 for protecting computer devices (for example, a motherboard) inside the housing 22. Furthermore, the housing 22 can be utilized to prevent the computer 10 from radiating electromagnetic interference (EMI) to the environment. The host 14 further comprises an optical disk drive 24, a floppy disk drive 26, and a power switch 27 for enabling users to turn on or turn off the computer 10. In addition, the keyboard 16 and the mouse 18 are respectively connected to PS/2 slots 32, 34 on the housing 22 through transmission lines 28, 30 respectively. The display 12 is connected to a display card 38 of the host 14 through a transmission line 36 to transfer image signals. Furthermore, the display 12 is connected to a power slot 42 of the host 14 through another transmission line 40 to receive power transferred by the power supplying device 44 of the host 14. The speaker 20 is connected to a sound card 48 in the back of the housing 22 through a transmission line 46 to transfer audio signals.

But the computer 10 has a disadvantage. Because the computer 10 comprises a separated host 14 and a display 12, the host 14 and the display 12 are placed in different locations. For example, the display 12 is placed on a table, but the host 14 is placed under the table. Therefore, the user is inconvenienced when utilizing the optical disk drive 24 or the floppy disk drive 26, or switching the power switch 27. Furthermore, because there are a multitude of transmission lines between the host 14 and display 12, it is difficult for users to organize these transmission lines.

Please refer to FIG. 3, which is a diagram of an all-in-one computer 60 according to the prior art. The computer 60 comprises a housing 62, a keyboard 64, and a mouse 66. Furthermore, almost all other computer devices (for example, motherboard, display, or other components) are installed inside the housing 62. In other words, the computer 60 is designed by integrating the display 12 and the host 14 of the computer 10 shown in FIG. 1 in the same housing (the housing 62). The computer 60 further comprises a power transmission line 68 for receiving power provided by an external power source, a printing transmission line 70 connected to an external printer, a network transmission line 72 for transferring external network data, and an image signal transmission line 74 for receiving image information provided from the outside circuit.

Although the all-in-one computer 60 can solve the above-mentioned problems of bad accessibility of the traditional computer 10, the all-in-one computer 60 still has many transmission lines connected to peripheral devices, making it still difficult for users to organize the transmission lines. Furthermore, in contrast to the traditional computer 10, the all-in-one computer device 60 has bad hardware expandability, is complex to produce and hard to maintain, and the cost of the computer 60 is more than that of the traditional computer 10. In addition, because the all-in-one computer 60 is placed on the table, the all-in-one computer 60 generates a lot of noise during operation, which can disturb the users more than in the traditional computer 10's operation.

To sum up, inventing a computer having good accessibility, good transmission line arrangement, convenience of production and maintenance, low cost, and low noise is a goal in today's computer industry.

### SUMMARY OF INVENTION

The present invention provides a computer system of combining user interface and a display device, to solve the above-mentioned problem.

According to an exemplary embodiment of the claimed invention, a computer system is disclosed. The computer system comprises: a first module; a second module; and a cable electrically connected to the first module and the second module. The first module comprises: a first housing; a motherboard installed inside the first housing, the motherboard comprising a central processing unit for processing programs and data of the computer system; and a power supplying device installed inside the first housing for providing power to the computer system. The second module comprises: a second housing; a display device installed inside the second housing; and a power switch installed inside the second housing for generating a power switching signal to control to turn on or turn off the power supplying device. The cable comprises a power switching signal transmission line for transferring the power switching signal generated by the power switch to the power supplying device.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a front-view diagram of the traditional computer of a separated host and a display according to the prior art.

FIG. 2 is a back-view diagram of the traditional computer shown in FIG. 1.

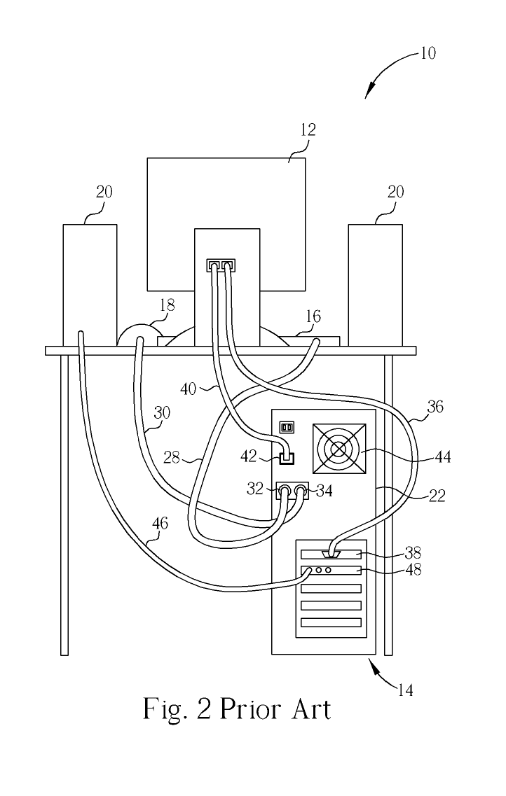

FIG. 3 is a diagram of an all-in-one computer according to the prior art.

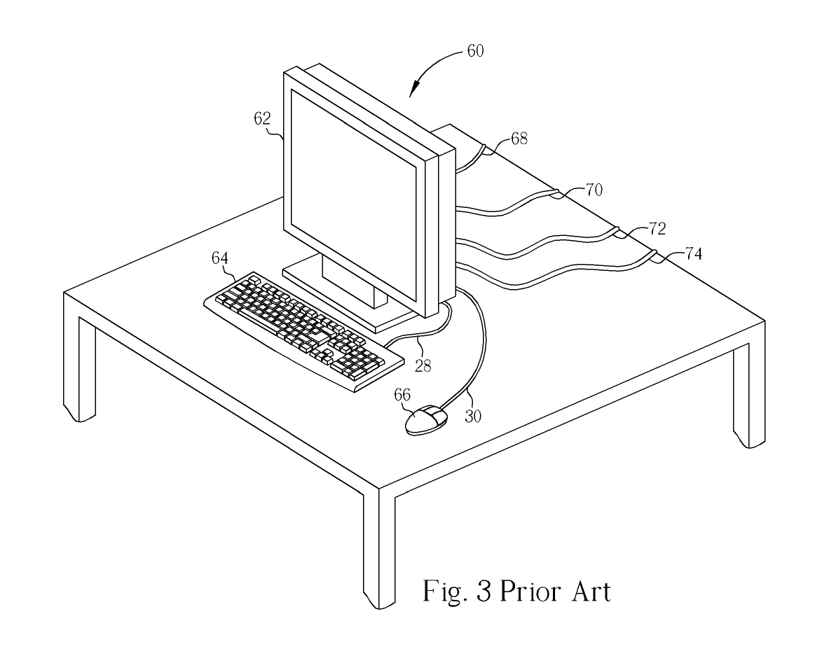

FIG. 4 is a front-view diagram of a computer system according to the present invention.

FIG. 5 is a back-view diagram of the computer system shown in FIG. 4.

FIG. 6 is a block diagram of the computer system shown in FIG. 4.

### DETAILED DESCRIPTION

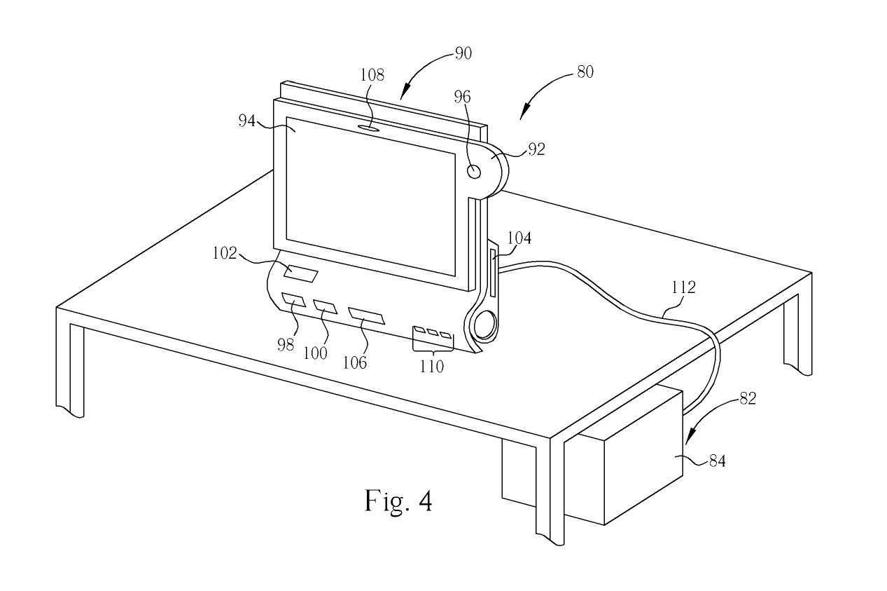

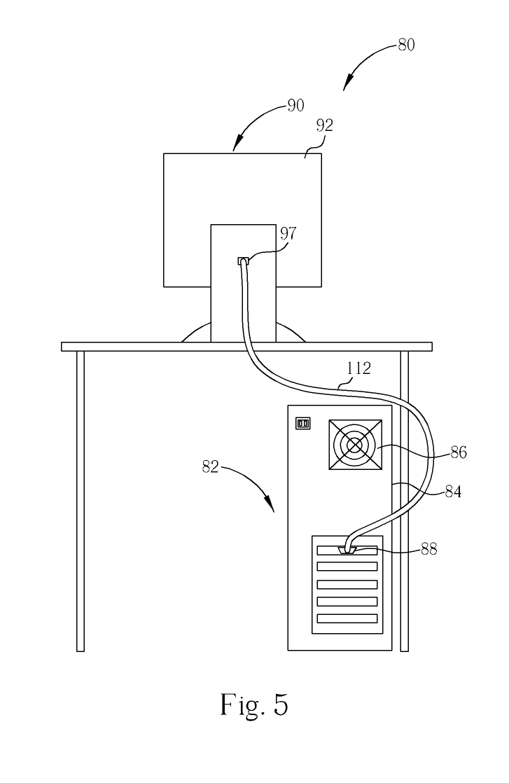

Please refer to FIG. 4 and FIG. 5. FIG. 4 is a front-view diagram of a computer system 80 according to the present invention. FIG. 5 is a back-view diagram of the computer system 80. The computer system comprises a first module 82, which is the host of the computer system 80. The first module 82 comprises a first housing 84 for protecting computer components (for example, the motherboard) installed inside the first housing 84. Furthermore, the first housing 84 can also be utilized to prevent inner components of the first module 82 radiating electromagnetic interference to the environment. The first module 82 further comprises a power supplying device 86 installed inside the first housing 84 for providing needed power to the computer system 80, and a first connecting port 88 installed on the first housing 84. The computer system 80 further comprises a second module 90, which is the display and the user interface of the computer system 80. The second module 90 comprises a second housing 92, and a display device 94 installed inside the second housing 92. Here, the display device 94 can be an LCD display. In addition, the second module 90 further comprises a power switch 96 installed on the second housing 92 for generating a power switching signal to control to turn on or turn off the power supplying device 86, a second connecting port 97 installed on the second housing 92, an audio outputting end 98 for outputting audio signals, an audio inputting end 100 for receiving audio signals, a wireless transmission device 102 for transferring data wirelessly, an optical disk drive 104, a card reader 106, a webcam 108, and a plurality of USB connectors 110 for providing the user to connect peripheral devices to the computer system 80, wherein the wireless transmission device 102 can utilize the bluetooth WLAN protocol to transfer data or utilize infrared rays to transfer data. In addition, the computer system 80 further comprises a cable 112 electrically connected to the first connecting port 88 of the first module 82 and the second connecting port 97 of the second module 90.

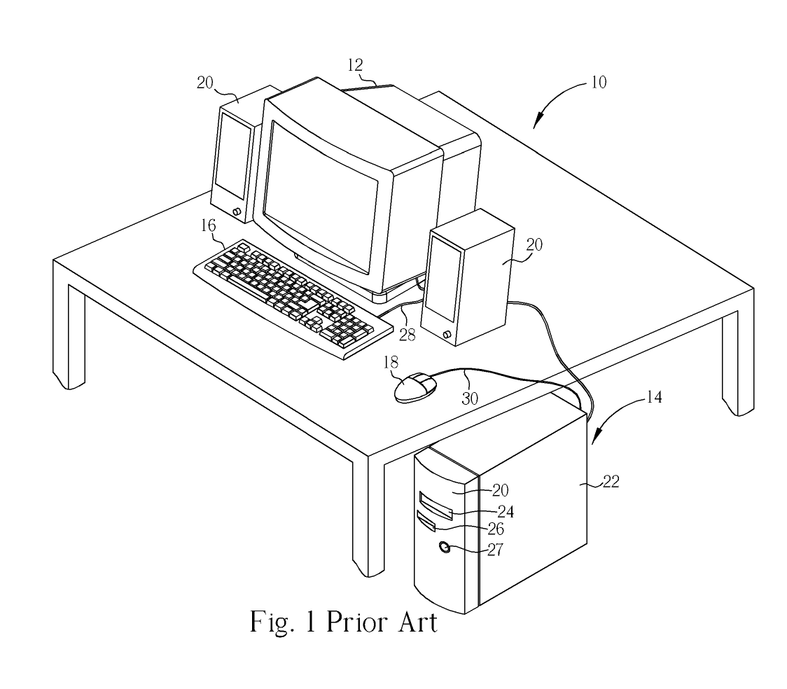

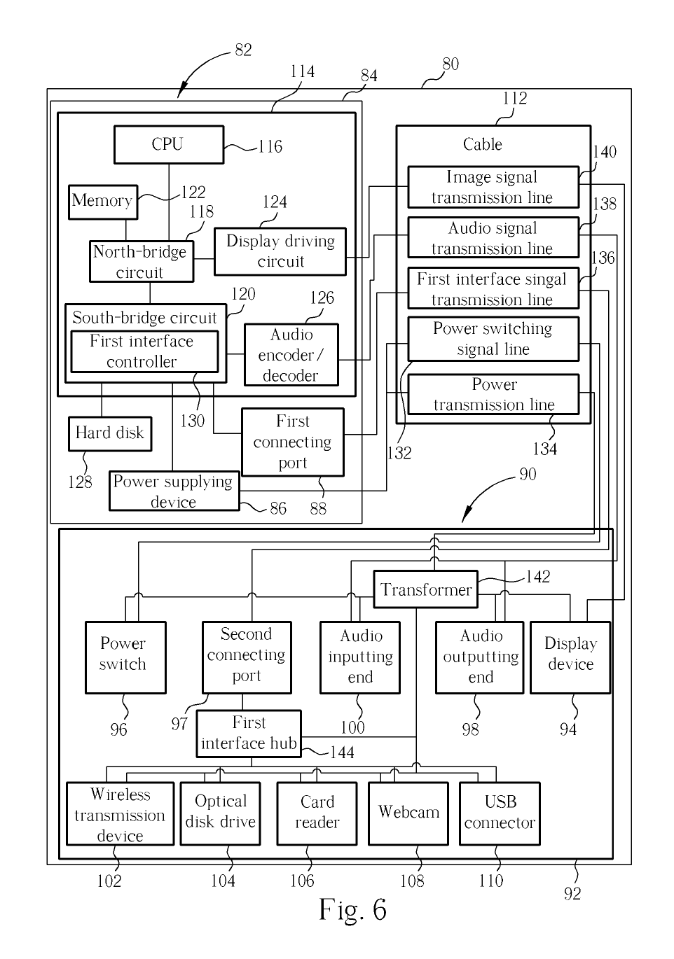

Please refer to FIG. 6, which is a block diagram of the computer system 80 shown in FIG. 1. The first module 82 of the computer system 80 further comprises a motherboard 114 installed inside the first housing 84, wherein the motherboard 114 has a CPU 116, a north-bridge circuit 118, a south-bridge circuit 120, a memory 122, a display driving circuit 124, and an audio encoder/decoder 126. The first module 82 further comprises a hard disk 128 installed in the first housing 84 and coupled to the south-bridge circuit 120 for storing data. The CPU 116 is utilized for processing the programs and data of the computer system 80 to control the operation of the computer system 80. The north-bridge circuit 118 is utilized for controlling signal transmission between the high-speed devices (for example, the display driving circuit 124 and the memory 122) and the CPU 116. The south-bridge circuit 120 is utilized for controlling signal transmission between low-speed devices (for example, the hard disk 128 and the optical disk drive) and the north-bridge circuit 118. The display driving circuit 124 is utilized for processing a 2-D graphic calculation or a 3-D graphic calculation to transform the image data into image signals in order to drive the display device 94 to display corresponding images. The audio encoder/decoder 126 is utilized for transforming audio signals into digital audio files or transforming the digital audio files into audio signals. Furthermore, the south-bridge circuit 120 has a first interface controller 130 for controlling data transmission on the first interface bus. Here, the first interface controller 130 can be a USB host controller for controlling data transmission on a USB bus.

The cable 112 of the computer system 80 comprises a power switching signal transmission line 132, a power transmission line 134, a first interface signal transmission line 136, an audio signal transmission line 138, and an image signal transmission line 140. In this embodiment, the power switching signal transmission line 132 is coupled to the power supplying device 86 and the power switch 96 for transferring power switching signals generated by the power switch 96 to control to turn on or turn off the power supplying device 86. This achieves the function of turning on/off the computer system 80. The power transmission line 134 is coupled to the power supplying device 86 and a transformer 142 of the second module 90 for transferring power generated by the power supplying device 86 to the transformer 142. The first interface signal transmission line 136 is coupled to the first connecting port 88 and second connecting port 97 for transferring signals between the first connecting port 88 and the second connecting port 97. The audio signal transmission line 138 is coupled to the audio encoder/decoder 126, the audio outputting end, and the audio inputting end 100 for transferring audio signals generated by the audio encoder/decoder 126 to the audio outputting end 98 and for transferring audio signals received by the audio inputting end to the audio encoder/decoder 126. The audio signal transmission line 140 is coupled to the display driving circuit 124 and the display device 94 for transferring the image signals generated by the display driving circuit 124 to the display device 94. The cable 112 can physically be a cable covered with an isolation layer. Furthermore, inside the isolation layer, the cable 112 comprises the power switching signal transmission line 132, the power transmission line 134, the first interface signal transmission line 136, the audio signal transmission line 138, and the image signal transmission line 140. When viewed from outside, however, only the isolation layer can be seen. In other words, only the cable 112 is seen instead of the power switching signal transmission line 132, the power transmission line 134, the first interface signal transmission line 136, the audio signal transmission line 138, and the image signal transmission line 140.

The second module 90 of the computer system 80 further comprises a first interface hub 144 installed in the second housing 92 and coupled to the second connecting port 97, the wireless transmission device 102, the optical disk drive 104, the card reader 106, the webcam 108, and the USB connector 110. In addition, the first interface hub 144 can distribute the transmission bandwidth of the above-mentioned devices. Therefore, the number of the first interface hub 144 is not limited to one. In other words, a plurality of first interface hubs 144 can be connected to the above-mentioned first interface hub 144. The number of first interface hubs 144 is determined according to the number of the devices and the transmission bandwidth arrangement. After the transformer 142 receives the power transferred by the power supplying device 86 of the first module 82 through the power transmission line 134 of the cable 112, the transformer 142 can transform the voltage of the received power into the working voltages of the inner devices of the second module 92 and transfer the working voltages to the above-mentioned inner devices. Furthermore, the user can utilize the power switch 96 to generate a power on signal or a power off signal, and the power switch 96 transfers the power on signal or the power off signal to the power supplying device 86 through the power switching signal transmission line 132 of the cable 112 in order to control to turn on or turn off the power supplying device 86. Therefore, the function of turning on and turning off the computer system 80 is achieved. In addition, the second connecting port 97 and the first connecting port 88 of the first module 84 can transfer data to each other through the first interface signal transmission line 136, and the first interface controller 130 can control the data transmission between the first connecting port 88 and the second connecting port 97 through the first interface bus. If the first interface is the USB interface (for example, USB 1.0, USB 2.0, or USB OTG interface), the first connecting port 88 and the second connecting port 97 are both USB connecting ports (for example, USB 1.0, USB 2.0, or USB OTG connecting ports), the first interface controller 130 is a USB interface controller, and the first interface hub 144 of the second module 92 is a USB hub. In other words, the wireless transmission device 102, the optical disk drive 104, the card reader 106, and the webcam 108 all utilize the USB interface to transfer data. Furthermore, the data transmission bandwidth among the wireless transmission device 102, the optical disk drive 104, the card reader 106, the webcam 108, peripheral devices connected to the USB connector 110 through the second connecting port 97, the first interface signal transmission line 136, the first connecting port 88, and the first interface controller 130 can be arranged by the first interface hub 144. The audio outputting end 98 can be an earphone jack or a speaker. The audio inputting end 100 can be a microphone. Furthermore, audio signals generated by the audio encoder/decoder 126 can be transferred to the audio outputting end 98 through the audio signal transmission line 138 of the cable 112, or audio signals received by the audio inputting end 100 can be transferred to the audio encoder/decoder 126 through the audio signal transmission line 138 of the cable 112. Furthermore, the display device 94 can receive image signals generated by the display driving circuit 124 through the image signal transmission line 140 of the cable and display corresponding images.

To sum up, the present invention computer system 80 can be divided into two parts, the first module 82 and the second module 90. The devices or interfaces (for example, the audio inputting end 100 for the user to input audio information, the data storage device such as the optical disk drive 104 or the card reader 106 for the user to access data of the computer system 80, the webcam 108 for catching images, the bus connector 110 for the user to connect an external peripheral device, and wireless transmission device 102 for transferring data to other devices), which are often utilized by the user, are installed in the second module 90. In addition, the devices, which the user does not often utilize, are installed in the first module 82. Basically, the devices installed in the first module 82 are the main components for maintaining the operation of the computer system 80. Therefore, the devices of the first module 82 can control the corresponding devices of the second module 90, and the control command and data transmission are transferred through transmission lines of the cable 112. So in contrast to the prior art traditional computer, the present invention computer system 80 can only utilize one cable 112 to connect the first module 82 to the second module 90. Therefore, the second module 90 can be placed on the table so that the accessibility is raised, and the first module 82 can be placed under the table. Furthermore, because the first module 82 is connected to the second module 90 through only one cable 112, the number of transmission lines is reduced, allowing the user to clean the table and arrange the cable 112 easily.

In contrast to the prior art, the present invention computer system utilizes only one cable to connect two modules. One of the modules is often utilized and contacted by the user, and the other module is not. The more frequently contacted module can be placed on the table and the less frequently contacted module can be placed under the table. The present invention computer system combines the display device and the user interface so that the accessibility is raised. Furthermore, because only one cable is utilized to connect the two modules, the complex transmission lines problem of the prior art is removed. In addition, the present invention computer still has good hardware expandability, so it is easier to produce and maintain the present invention computer system than the prior art all-in-one computer. The cost of the present invention computer system is lower than the prior art all-in-one computer. Furthermore, because the host (first module) of the present invention computer system is still separated from the user interface and the display device (the second module), the noise when the computer is operating is much lower than the prior art all-in-one computer. To sum up, the present invention computer system has the advantages of good accessibility, transmission line arrangement convenience, low cost, ease of production and maintenance, and low noise.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computer system comprising:
a first module comprising:
a first housing;
a motherboard installed inside the first housing, the motherboard comprising a central processing unit for processing programs and data of the computer system; and
a power supplying device installed inside the first housing for providing power to the computer system;
a second module comprising:
a second housing;
a display device installed inside the second housing; and
a power switch installed inside the second housing for generating a power switching signal to control to turn on or turn off the power supplying device; and
a cable electrically connected to the first module and the second module, the cable comprising:
a power switching signal transmission line for transferring the power switching signal generated by the power switch to the power supplying device.

2. The computer system of claim 1, wherein the second module further comprises a transformer for transforming the power transferred from the power supplying device and transferring the transformed power to the display device, and the cable further comprises a power transmission line coupled to the power supplying device and the transformer for transferring the power generated by the power supplying device to the transformer.

3. The computer system of claim 1, wherein the motherboard further comprises a first interface controller, the first module further comprises a first connecting port coupled to the first interface controller, the second module further comprises a second connecting port installed on the second housing, and the cable further comprises a first interface signal transmission line coupled to the first connecting port and the second connecting port for transferring a signal between the first connecting port and the second connecting port.

4. The computer system of claim 3, wherein the first connecting port and the second connecting port are both universal serial bus (USB) interfaces.

5. The computer system of claim 4, wherein the first connecting port and the second connecting port are USB 1.0, USB 2.0 or USB OTG (USB On-The-Go) interfaces.

6. The computer system of claim 3, wherein the first interface controller is a USB controller.

7. The computer system of claim 4, wherein the second module further comprises a USB hub installed inside the second housing and coupled to the second connecting port.

8. The computer system of claim 1, wherein the motherboard of the first module further comprises an audio encoder/decoder for transforming a digital audio file into an audio signal or transforming an audio signal into a digital audio file.

9. The computer system of claim 8, wherein the second module further comprises an audio outputting end for outputting the audio signal transformed by the audio encoder/decoder, and the cable further comprises an audio signal transmission line for transferring the audio signal to the audio outputting end.

10. The computer system of claim 9, wherein the audio outputting end is an earphone jack.

11. The computer system of claim 9, wherein the audio outputting end is a speaker.

12. The computer system of claim 8, wherein the second module further comprises an audio inputting end for receiving an audio signal, and the cable further comprises an audio signal transmission line for transferring the received audio signal to the audio encoder/decoder.

13. The computer system of claim 12, wherein the audio inputting end is a microphone.

14. The computer system of claim 3, wherein the second module further comprises a wireless transmission device coupled to the second connecting port for transferring data wirelessly.

15. The computer system of claim 14, wherein the wireless transmission device utilizes a bluetooth technique WLAN protocol to transfer data.

16. The computer system of claim 14, wherein the wireless transmission device utilizes infrared rays to transfer data.

17. The computer system of claim 3, wherein the second module further comprises a data storage device coupled to the second connecting port.

18. The computer system of claim 17, wherein the data storage device is an optical disk drive.

19. The computer system of claim 17, wherein the data storage device is a card reader.

20. The computer system of claim 3, wherein the second module further comprises a webcam installed on the second housing and coupled to the second connecting port.

21. The computer system of claim 1, wherein the motherboard further comprises a display driving circuit for transforming image data into image signals, and the cable further comprises an image signal transmission line coupled to the display driving circuit and the display device for transferring the image signals generated by the display driving circuit to the display device.
